(19) United States
(12) Patent Application Publication
(10) Pub. No.: US 2026/0001267 A1
(43) Pub. Date: Jan. 1, 2026

(54) ESCR IMPROVEMENT WITH GRAPHENE

(71) Applicant: TECHMER PM, LLC, Clinton, TN (US)

(72) Inventors: Steve SMITH, Clinton, TN (US); Steven Harold WILLIAMS, Clinton, TN (US); Bhushan Janardan DESHPANDE, Clinton, TN (US)

(73) Assignee: TECHMER PM, LLC, Clinton, TN (US)

(21) Appl. No.: 19/257,059

(22) Filed: Jul. 1, 2025

Related U.S. Application Data
(60) Provisional application No. 63/666,545, filed on Jul. 1, 2024.

(51) Int. Cl. B29C 49/00; B29L 31/00; C08J 3/22

(52) U.S. Cl. CPC B29C 49/0005; C08J 3/22; B29K 2907/04; B29L 2031/7158; C08J 2323/06

(57) ABSTRACT

The present disclosure relates to a masterbatch composition comprising 10 to 30 wt % of a graphene component and 60 to 90 wt % a carrier resin, wherein the graphene component has a particle size of 1 to 2 uM and a bulk density of 0.2 to 0.3 g/cm³.

### CROSS REFERENCE TO RELATED APPLICATION

This application claims the benefit of U.S. provisional application Ser. No. 63/666,545 filed Jul. 1, 2024, the disclosure of which is hereby incorporated in its entirety by reference herein.

### TECHNICAL FIELD

The present disclosure generally relates to the use of graphene in blow molded bottle manufacturing.

### BACKGROUND

Blow molded bottles are used as a safe alternative to glass for storing solutions such as bleach, liquid detergents, motor oil, industrial chemicals, and others. Blow molded bottles, however, are susceptible to environmental stress cracking which reduces the utility and safety of the bottles over time.

### SUMMARY

In at least an aspect, a masterbatch composition is provided. The masterbatch composition may comprise 10 to 30 wt % of a graphene component; and 60 to 90 wt % a carrier resin, wherein the graphene component has a particle size of 1 to 2 uM and a bulk density of 0.2 to 0.3 g/cm3.

In at least another aspect, a masterbatch composition is provided. The masterbatch composition may comprise 10 to 30 wt % of a graphene component; and 60 to 90 wt % a carrier resin, wherein the graphene component has a particle size of 0.5 to 1 uM and a bulk density of 0.14 g/cm3.

In at least another aspect, a blend is provided. The blend may comprise 1 to 7% of a masterbatch composition including 10 to 30 wt % of a graphene component, and 60 to 90 wt % a carrier resin, wherein the graphene component has a particle size of 1 to 2 uM and a bulk density of 0.2 to 0.3 g/cm3; and a base resin.

In at least another aspect, a method for manufacturing a plastic container comprises adding the masterbatch to a base resin to form a mixture; heating the mixture so that the masterbatch composition is melted together with the base resin; cooling the mixture; and extruding the mixture into pellets. In at least another aspect, a method for manufacturing a plastic container comprises adding the masterbatch composition to a base resin to form a mixture; heating the mixture so that the masterbatch composition is melted together with the base resin; cooling the mixture; and extruding the mixture into pellets.

### BRIEF DESCRIPTION OF THE DRAWINGS

For a further understanding of the nature, objects, and advantages of the present disclosure, reference should be made to the following detailed description, read in conjunction with the following drawings, wherein like reference numerals denote like elements and wherein:

FIG. 1 illustrates bent strip test results for 100% prime resin.

FIG. 2 illustrates bent strip testing for 100% post-consumer resin (PCR).

FIG. 3 illustrates bent strip testing for 50% PCR resin.

FIG. 4 illustrates bent strip testing for 75% PCR resin.

FIG. 5 illustrates bent strip testing for a graphene master batch according to an embodiment.

FIG. 6 illustrates bent strip testing for a graphene master batch according to an embodiment.

FIG. 7 illustrates a plot of the bent strip testing results for the samples tested in FIGS. 1 through 6.

FIG. 8 illustrates blow molded bottles according to an embodiment after drop testing.

FIG. 9 illustrates a scatter plot of weight versus load at break for blow molded control bottles and bottles according to various embodiments.

FIG. 10 illustrates a scatter plot of weight versus load at yield for control bottles and blow molded bottles according to various embodiments.

FIG. 11 illustrates images of environmental stress cracking in tested bottles according to various embodiments.

### DETAILED DESCRIPTION

Reference will now be made in detail to presently preferred compositions, embodiments and methods of the present invention, which constitute the best modes of practicing the disclosure presently known to the inventors. The Figures are not necessarily to scale. However, it is to be understood that the disclosed embodiments are merely exemplary of the disclosure that may be embodied in various and alternative forms. Therefore, specific details disclosed herein are not to be interpreted as limiting, but merely as a representative basis for any aspect of the disclosure and/or as a representative basis for teaching one skilled in the art to variously employ the present disclosure.

Except in the examples, or where otherwise expressly indicated, all numerical quantities in this description indicating amounts of material or conditions of reaction and/or use are to be understood as modified by the word “about” in describing the broadest scope of the disclosure. Practice within the numerical limits stated is generally preferred. Also, unless expressly stated to the contrary: all R groups (e.g. Rᵢ where i is an integer) include hydrogen, alkyl, lower alkyl, C₁₋₆ alkyl, C₆₋₁₀ aryl, C₆₋₁₀ heteroaryl, alylaryl (e.g., C₁₋₈ alkyl C₆₋₁₀ aryl), —NO₂, —NH₂, —N(R′R″), —N(R′R″R′″)⁺L⁻, Cl, F, Br, —CF₃, —CCl₃, —CN, —SO₃H, —PO₃H₂, —COOH, —CO₂R′, —COR′, —CHO, —OH, —OR′, —O-M⁺, —SO₃⁻M⁺, —PO₃⁻M⁺, —COO⁻M⁺, —CF₂H, —CF₂R′, —CFH₂, and —CFR′R″ where R′, R″ and R′″ are C₁₋₁₀ alkyl or C₆₋₁₈ aryl groups, M⁺ is a metal ion, and L⁻ is a negatively charged counter ion; R groups on adjacent carbon atoms can be combined as —OCH₂O—; single letters (e.g., “n” or “o”) are 1, 2, 3, 4, or 5; in the compounds disclosed herein a CH bond can be substituted with alkyl, lower alkyl, C₁₋₆ alkyl, C₆₋₁₀ aryl, C₆₋₁₀ heteroaryl, —NO₂, —NH₂, —N(R′R″), —N(R′R″R′″)⁺L⁻, Cl, F, Br, —CF₃, —CCl₃, —CN, —SO₃H, —PO₃H₂, —COOH, —CO₂R′, —COR′, —CHO, —OH, —OR′, —O⁻M⁺, —SO₃⁻M⁺, —PO₃⁻M⁺, —COO⁻M⁺, —CF₂H, —CF₂R′, —CFH₂, and —CFR′R″ where R′, R″ and R′″ are C₁₋₁₀ alkyl or C₆₋₁₈ aryl groups, M⁺ is a metal ion, and L⁻ is a negatively charged counter ion; hydrogen atoms on adjacent carbon atoms can be substituted as —OCH₂O—; when a given chemical structure includes a substituent on a chemical moiety (e.g., on an aryl, alkyl, etc.) that substituent is imputed to a more general chemical structure encompassing the given structure; percent, “parts of,” and ratio values are by weight; the term “polymer” includes “oligomer,” “copolymer,” “terpolymer,” and the like; molecular weights provided for any polymers refers to weight average molecular weight unless otherwise indicated; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It must also be noted that, as used in the specification and the appended claims, the singular form “a,” “an,” and “the” comprise plural referents unless the context clearly indicates otherwise. For example, reference to a component in the singular is intended to comprise a plurality of components.

As used herein, the term “about” means that the amount or value in question may be the specific value designated or some other value in its neighborhood. Generally, the term “about” denoting a certain value is intended to denote a range within +/−5% of the value. As one example, the phrase “about 100” denotes a range of 100+/−5, i.e., the range from 95 to 105. Generally, when the term “about” is used, it can be expected that similar results or effects according to the disclosure can be obtained within a range of +/−5% of the indicated value.

As used herein, the term “and/or” means that either all or only one of the elements of said group may be present. For example, “A and/or B” shall mean “only A, or only B, or both A and B”. In the case of “only A”, the term also covers the possibility that B is absent, i.e. “only A, but not B”.

It is also to be understood that this disclosure is not limited to the specific embodiments and methods described below, as specific components and/or conditions may, of course, vary. Furthermore, the terminology used herein is used only for the purpose of describing particular embodiments of the present disclosure and is not intended to be limiting in any way.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

The phrase “composed of” means “including” or “consisting of” Typically, this phrase is used to denote that an object is formed from a material.

With respect to the terms “comprising,” “consisting of,” and “consisting essentially of,” where one of these three terms is used herein, the presently disclosed and claimed subject matter can include the use of either of the other two terms.

The term “one or more” means “at least one” and the term “at least one” means “one or more.” The terms “one or more” and “at least one” include “plurality” and “multiple” as a subset. In a refinement, “one or more” includes “two or more.”

The term “substantially,” “generally,” or “about” may be used herein to describe disclosed or claimed embodiments. The term “substantially” may modify a value or relative characteristic disclosed or claimed in the present disclosure. In such instances, “substantially” may signify that the value or relative characteristic it modifies is within ±0%, 0.1%, 0.5%, 1%, 2%, 3%, 4%, 5% or 10% of the value or relative characteristic.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4 . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits.

When referring to a numeral quantity, in a refinement, the term “less than” includes a lower non-included limit that is 5 percent of the number indicated after “less than.” For example, “less than 20” includes a lower non-included limit of 1 in a refinement. Therefore, this refinement of “less than 20” includes a range between 1 and 20. In another refinement, the term “less than” includes a lower non-included limit that is, in increasing order of preference, 20 percent, 10 percent, 5 percent, or 1 percent of the number indicated after “less than.”

In the examples set forth herein, concentrations, temperature, and reaction conditions (e.g., pressure, pH, flow rates, etc.) can be practiced with plus or minus 50 percent of the values indicated rounded to or truncated to two significant figures of the value provided in the examples. In a refinement, concentrations, temperature, and reaction conditions (e.g., pressure, pH, flow rates, etc.) can be practiced with plus or minus 30 percent of the values indicated rounded to or truncated to two significant figures of the value provided in the examples. In another refinement, concentrations, temperature, and reaction conditions (e.g., pressure, pH, flow rates, etc.) can be practiced with plus or minus 10 percent of the values indicated rounded to or truncated to two significant figures of the value provided in the examples.

For all compounds expressed as an empirical chemical formula with a plurality of letters and numeric subscripts (e.g., CH₂O), values of the subscripts can be plus or minus 50 percent of the values indicated rounded to or truncated to two significant figures. For example, if CH₂O is indicated, a compound of formula C_{(0.8-1.2)}H_{(1.6-2.4)}O_{(0.8-1.2)}. In a refinement, values of the subscripts can be plus or minus 30 percent of the values indicated rounded to or truncated to two significant figures. In still another refinement, values of the subscripts can be plus or minus 20 percent of the values indicated rounded to or truncated to two significant figures.

The term “extruder” as used herein means a machine used to extrude viscous substances, including but not limited to polymers, into high quality structured products by controlling the processing conditions.

The term “extrusion” as used herein means the process of forcing melted polymer pellets or granules through a die with an opening.

Throughout this application, where publications are referenced, the disclosures of these publications in their entireties are hereby incorporated by reference into this application to more fully describe the state of the art to which this disclosure pertains.

The following examples illustrate the various embodiments of the present disclosure. Those skilled in the art will recognize many variations that are within the spirit of the present disclosure and scope of the claims.

In the late 1930's Enoch Ferngren and William Kopitke applied the principles of glass blowing to plastics and produced the first machine for plastic blow molding. Plastic blow molding, which is similar to glass blowing, involves blowing air through an apparatus to alter the shape of a plastic. Blow molding may be combined with molds to create complex shapes. Starting in the 1940's and 1950's, manufacturers began producing blow molded plastic bottles for industrial, cosmetic, food, chemical and other applications. In addition to liquid containers, blow molded containers for solid items and even blow molded Christmas decorations were produced. Blow molded plastic bottles may be used as a safe alternative to glass for storing solutions such as soda, milk, cosmetic liquids, bleach, liquid detergents, motor oil, industrial chemicals, and others.

Blow molded plastics, however, are susceptible to environmental stress cracking which reduces their utility and safety over time. High density polyethylene (HDPE) which is a plastic that is commonly used in blow molding applications is a crystalline material with semi-crystalline characteristics. Due to its high density, HDPE will stretch and yield before ductile failure under high tensile strength. Under low tensile strength, however, HDPE will fail suddenly with a smooth break. This failure is known as environmental stress cracking (ESC). UV light exposure, high temperature oxidation, and/or low temperature contraction can lead to ESC. Because these environmental factors are nearly impossible to avoid, there is a need for plastics compositions that are highly resistant to ESC. In addition, millions of pounds of HDPE products are produced and disposed of annually. As such, there is a need for plastics compositions that both include a substantial amount of post-consumer resin (PCR) and are highly resistant to ESC.

In at least an embodiment, a masterbatch composition is provided for use in manufacturing a plastic container having improved environmental stress cracking resistance (ESCR). The plastic container may be a bottle, drum, or other similar container. The plastic container may include from 40 to 100 wt % PCR. The plastic container may for example be a blow molded bottle. The blow molded bottle may hold solutions including but not limited to bleach, liquid detergents, motor oil, industrial chemicals, and others.

The masterbatch composition may include graphene and a carrier resin. The masterbatch composition may additionally include waxes. For example, the masterbatch composition may include polyolephin and/or maleated waxes. The masterbatch composition may also include stearates and/or amide chemistries.

In at least an embodiment, the graphene component may range from 10 to 35 wt % of the total weight of the masterbatch. In other embodiments, the graphene component may range from 12 to 32 wt % of the total weight of the masterbatch. In at least an embodiment, the graphene component may range from 15 to 30 wt % of the total weight of the masterbatch. The masterbatch composition may not include more than 40 wt % graphene. More than 40 wt % prevents proper distribution and/or dispersion of the graphene within the resin. The graphene component may be supplied in powder form, with a primary particle size of 1-2 uM. The graphene component may have an agglomerate size of D50<38 uM. In an example, the agglomerate size of the graphene component may be 14 uM. The graphene component may have greater than 96 wt % graphene and less than 1 wt % oxygen. The graphene component may range from 6 to 10 layers. The graphene component may have a bulk density of 0.2 to 0.3 g/cm3 and be insoluble. The graphene component may have less than 0.5 wt % moisture and less than 4 wt % ash content. In an example, the graphene component may be GrapheneBlack™ 3X, supplied by NanoXplore of Montreal, Quebec.

In other embodiments, the graphene component may be supplied in powder form, with a primary particle size of 0.5 to 1 uM. The graphene component may have an agglomerate size of D50<13 uM. The graphene component may have greater than 96 wt % graphene and less than 1 wt % oxygen. The graphene component may range from 6 to 10 layers. The graphene component may have a bulk density of 0.14 g/cm³ and be odorless and insoluble. The graphene component may have less than 0.6 wt % moisture and from 2 to 3 wt % ash content. In an example, the graphene component may be GrapheneBlack™ OX, supplied by NanoXplore of Montreal, Quebec.

In at least an embodiment, the carrier resin may range from 60 to 90 wt % of the total weight of the masterbatch. In other embodiments, the carrier resin may range from 65 to 85 wt % of the total weight of the masterbatch. The carrier resin may be a linear low-density polyethylene (LLDPE). The carrier resin for example, may be a butene linear low density polyethylene resin. The melt flow rate of the carrier resin may range from around 7 to 20 g/10 min. at 190 C. The melt flow rate of the carrier resin should be higher than the melt flow rate of the base resin to which it is added. The melt flow rate of the base resin may be 1 or below. The melt flow rates of the carrier resin and of the base resin may be tested using method ASTM1238.

In at least an embodiment, the polyolephin wax may range from 1 to 5 wt % of the total weight of the masterbatch. The maleated wax may range from 1 to 3% of the total weight of the masterbatch. The stearate may range from 0.25 to 1 wt % of the total weight of the masterbatch. The amide chemistries may range from 0.2 to 0.5 wt % of the total weight of the masterbatch.

To generate the masterbatch composition, the graphene powder, carrier resin, polyolephin wax, maleated wax, stearate, amide chemistries, and other optional components may be heated, mixed, and melted together. The mixture may then be extruded using a single screw or a twin screw extruder, for example. The extruded mixture may then be cooled and formed into pellets, flakes, granules, powders, pellets, or other suitable masterbatch forms for use in blow molding and/or other suitable applications.

The masterbatch may be added at a letdown rate of 1 to 5% to a base resin to form a blend or a plastic container. The masterbatch when added to a base resin to manufacture a plastic container, may improve ESCR in the plastic container. Inclusion of the masterbatch in the plastic container may lead to downgauging and may also increase the amount of PCR resin that may be included in the plastic container without reducing performance. These results may promote greater sustainability and longer shelf-life of both the plastic container and its contents.

In at least an embodiment, a blend is provided for use in manufacturing a plastic container. The plastic container may be manufactured by blow molding. The plastic container may be a blow molded bottle for example. The blend may include the masterbatch and a base resin. The base resin may comprise prime high density polyethylene (HDPE). The base resin may comprise a unimodal or a bimodal HDPE. The base resin may have a melt flow rate of 1 g/10 min at 190° C. or below. The melt flow rate of the base resin should be lower than the melt flow rate of the carrier resin to promote incorporation of the masterbatch into the base resin. The melt flow rates of the carrier resin and of the base resin may be tested using method ASTM1238. The base resin may alternatively comprise post-consumer recycled (PCR) or post-industrial (PIR) recycled resin. The base resin may comprise a blend of prime and PCR or PIR resin. In an embodiment, the base resin may comprise 40 to 100 wt % PCR or PIR with the remainder comprising prime HDPE. For example, the base resin may comprise 40, 45, 50, 55, 60, 65, 70, 75, 80, 85, 90, 95, or 100 wt % PCR or PIR. In other embodiments, the base resin may comprise 50 to 100 wt % PCR or PIR. In yet other embodiments, the base resin may comprise 75 to 95 wt % PCR or PIR.

To generate the blend, the masterbatch may be added to a base resin at a letdown ratio ranging from 1 to 7 wt %, based on the total weight of the blend. For example, the masterbatch may be added to a base resin at about 1, 2, 3, 4, 5, 6, or 7 wt %. In other embodiments, the masterbatch may be added to a base resin at a letdown ratio ranging from 2 to 6 wt %. In yet other embodiments, the masterbatch may be added to a base resin at a letdown ratio ranging from 3 to 5 wt % A letdown ratio of 3% for example, means that the blend contains 3 wt % of the masterbatch and 97 wt % of the base resin. In at least an embodiment, the blend may be formed into a pellet.

In at least an embodiment, the masterbatch may be added to a base resin suitable for making a plastic container. The plastic container may be manufactured by blow molding. The plastic container may be a blow molded bottle for example. The blow molded bottle may be manufactured via wheel (rotary) or vertical methods of blow molding bottles. The base resin may comprise prime high density polyethylene (HDPE). The base resin may comprise a unimodal or a bimodal HDPE. The base resin may have a melt flow rate of 1 g/10 min at 190° C. or below. The melt flow rate of the base resin should be lower than the melt flow rate of the carrier resin to promote incorporation of the masterbatch into the base resin. The base resin may alternatively comprise post-consumer recycled (PCR) or post-industrial (PIR) recycled resin. The base resin may comprise a blend of prime and PCR or PIR resin. In an embodiment, the base resin may comprise 40 to 100 wt % PCR or PIR with the remainder comprising prime HDPE. For example, the base resin may comprise 40, 45, 50, 55, 60, 65, 70, 75, 80, 85, 90, 95, or 100 wt % PCR or PIR. In other embodiments, the base resin may comprise 50 to 100 wt % PCR or PIR. In yet other embodiments, the base resin may comprise 75 to 95 wt % PCR or PIR.

The plastic container may comprise a monolayer or it may include multiple layers. Each layer may comprise prime HDPE, or each layer may comprise PCR or PIR, or each layer may comprise a blend of prime HDPE and PCR or PIR. Any layer may also include regrind resin which is recaptured scrap resin produced during the manufacturing process. Any layer for example may include from 0 to 100 wt % of regrind resin. The composition of each layer may be the same as each other layer. Alternatively, the composition of a layer may differ from any of the other layers. The masterbatch may be included in only one layer or in more than one layer or in all of the layers. In an embodiment, the plastic container may include three layers. For example, the plastic container may include an outer, a middle, and an inner layer. In an embodiment, the outer layer may comprise prime HDPE and a colorant. The middle layer may comprise the masterbatch, PCR, and regrind resin. The inner layer may comprise prime HDPE. Each layer may be of a thickness that is equal to the thickness of any one of the other layers. Each layer may alternatively be of a thickness that is different from the thickness of one or more of the other layers. The plastic container may be produced in a 20/70/10 layer structure. For example, the first layer may be of a thickness that measures 20% of the total thickness. The second layer may be of a thickness that measures 70% of the total thickness, and the third layer may be of a thickness that measures 10% of the total thickness.

The masterbatch and the blend may be used with additives including but not limited to one or more pigments, and/or additives that result in a soft texture for plastic containers made using the masterbatch.

### EXAMPLES

### Example 1: Bent Strip Testing

Bent Strip testing according to ASTM D1693 was designed at Bell Laboratories in the R&D department of Western Electric in the 1930's. During this test, a strip of HDPE is cut from a sample and bent into a U shape inside of a test tube along with a wetting agent. The bending applies tensile strength on the outer radius of the bend. The recorded test measurement can be the length of time in hours until the specimen cracks. Measurements can also be recorded as a percentage of strips that have broken after a specific amount of time.

Test strips from the samples listed below were prepared and incubated with 10% IGEPAL in water at 50° C. for one week. The number of strips of each sample that broke within that week were observed and the percent broken was calculated for each sample.

The samples tested are listed below. The general composition as well as the average thickness of the samples are noted. Sample 1 is 100% prime resin. Sample 2 is 100% PCR resin. Sample 3 is 50% PCR with no graphene added. Sample 4 is 75% PCR with no graphene added. Sample 5 has 70% PCR with 3% of the masterbatch according to an embodiment added only to the middle layer. According to this particular embodiment, the masterbatch comprises 15% graphene and 85% carrier resin. The graphene component was supplied in powder form, with a primary particle size of 1-2 uM. The graphene component had an agglomerate size of D50<38 uM. The graphene component had greater than 96 wt % graphene and less than 1 wt % oxygen. The graphene component ranged from 6 to 10 layers, had a bulk density of 0.2 to 0.3 g/cm3 and was insoluble. The graphene component had less than 0.5 wt % moisture and less than 4 wt % ash content. Sample 6 is PCR in every layer with 7% of the masterbatch used in Sample 5 added to all three layers.

| | Sample | Average Thickness |
|---|---|---|
| 1 | 100% Prime | 0.798 |
| 2 | 100% PCR | 0.735 |
| 3 | Control 1: 50% PCR | 0.78 |
| 4 | Control 2: 75% PCR | 0.824 |
| 5 | 70% PCR, 3% MB in middle layer | 0.729 |
| 6 | All PCR, 7% MB in all layers | 0.75 |

### Bent Strip Test Results:

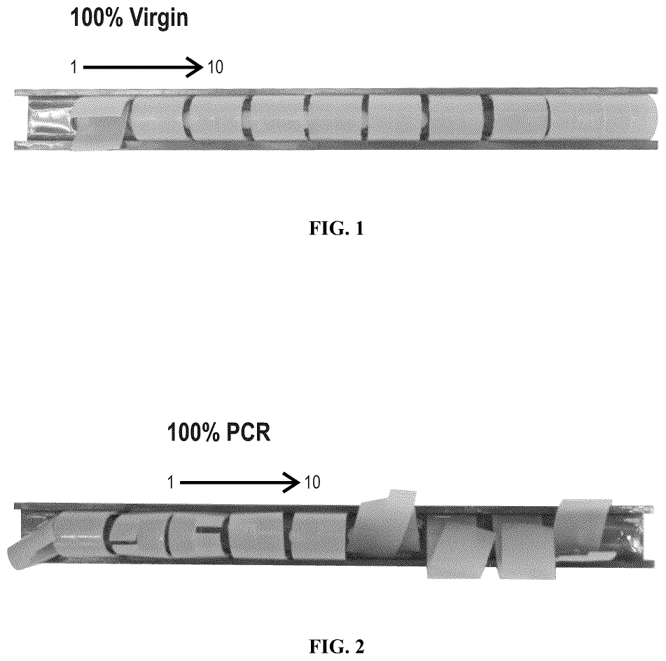

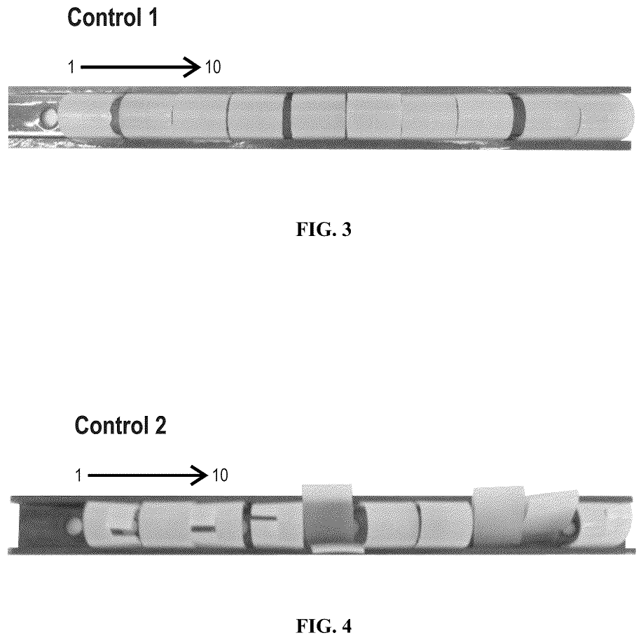

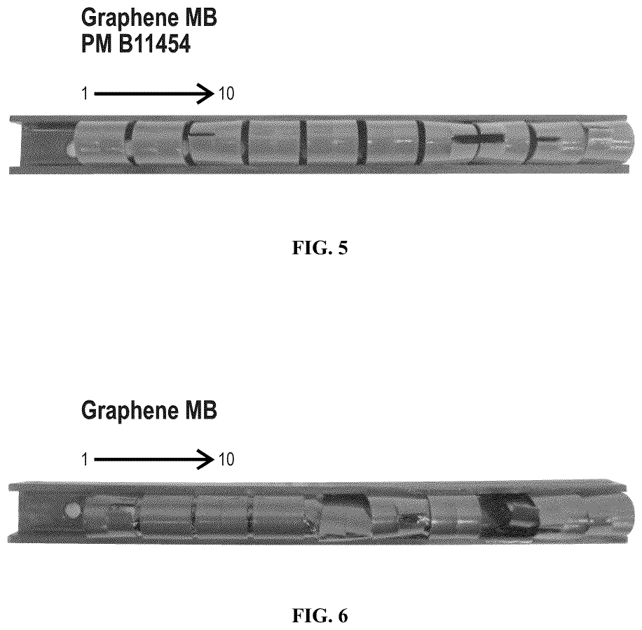

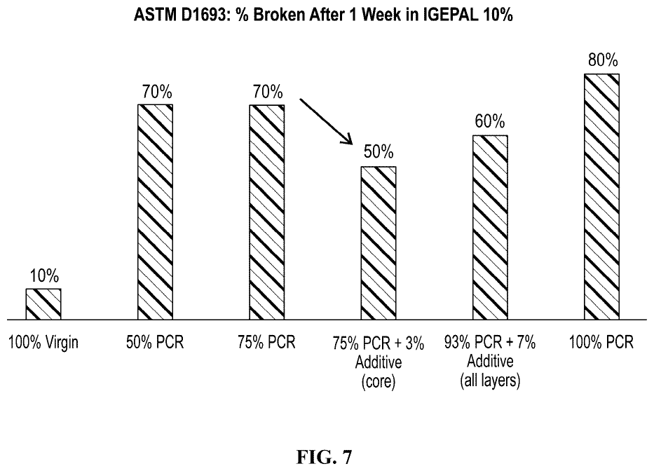

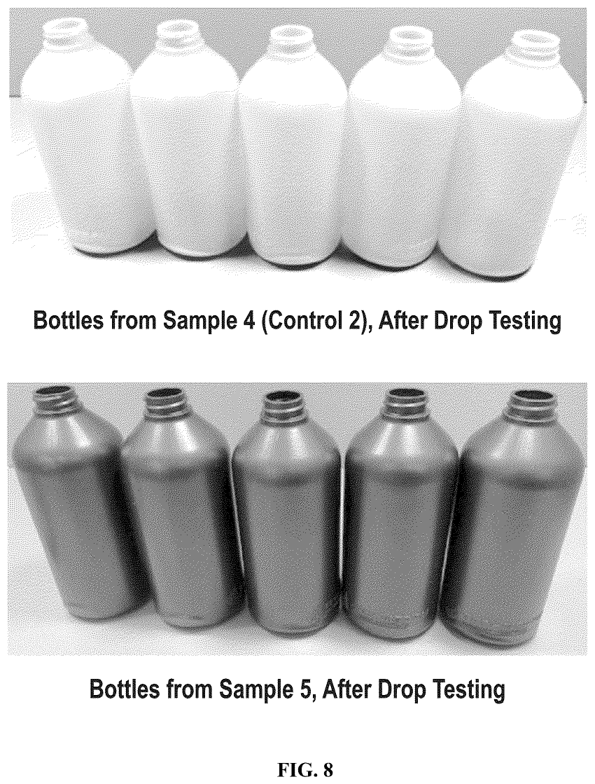

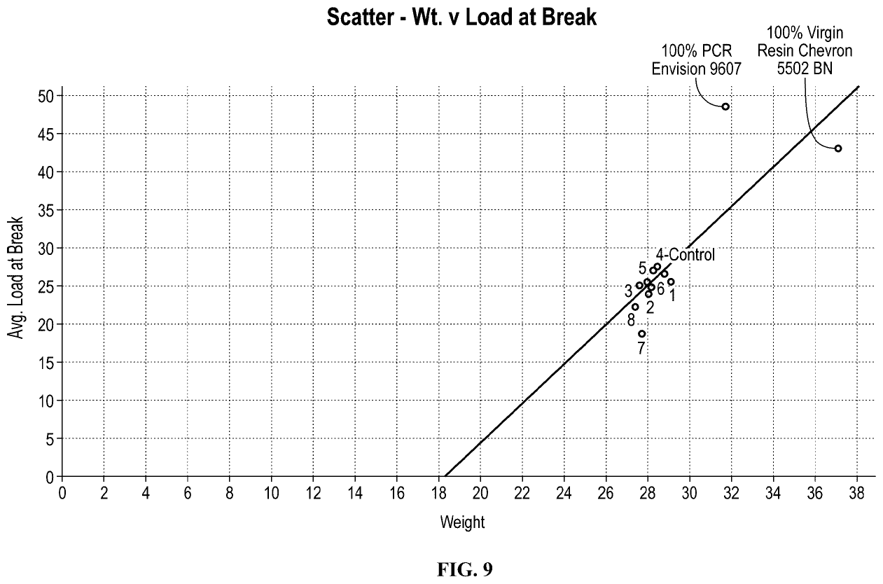

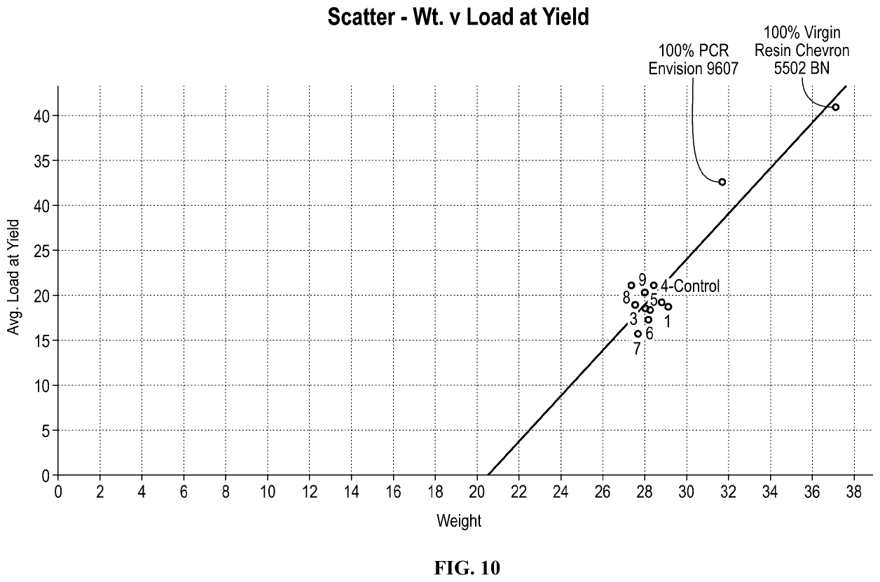

The percentage of strips from each sample after one week in 10% IGEPAL is detailed below. Images of the bent strips are illustrated in FIGS. 1 through 6.

| Sample | % Broken at 1 week |
|---|---|
| 100% Prime | 10 |
| 100% PCR | 80 |
| Control 1: 50% PCR | 70 |
| Control 2: 75% PCR | 70 |
| 70% PCR, 3% MB in middle layer | 50 |
| Al PCR, 7% MB in all layers | 60 |

### Example 2: Drop Testing and Top Load Testing

Ten samples having the following compositions were tested:
1: 75% PCR in all 3 layers, 9% MB in middle layer
2: 75% PCR in all 3 layers, 5% MB in middle layer
3: 75% PCR in all 3 layers, 3% MB in middle layer
4: 75% PCR in all 3 layers (Control 1)
5: 93% PCR+7% MB in all 3 layers (no prime)
6: 75% PCR in all 3 layers, 7% MB in middle layer
7: 75% PCR in all 3 layers, 1% MB in middle layer
8: 50% PCR in outer layers, 97% PCR+3% MB in middle layer
9: 50% PCR in outer layers, 100% PCR in middle layer
10: 50% PCR in all 3 layers (Control 2)

### Drop Testing:

Drop Testing according to method ASTM D243 involves filling blow molded bottles with water and dropping them from a height (i.e., 4 feet or higher) onto a hard floor (i.e., concrete) to determine whether the impact deforms or breaks the bottles.

### Drop Testing Results:

| Sample | Bottles Deformed | Comments |
|---|---|---|
| 1 | all 5 deformed | 2 of 5 with slight deformation |
| 2 | all 5 deformed | 2 of 5 with slight deformation |
| 3 | all 5 deformed | 5 of 5 with slight deformation |
| 4 | all 5 deformed | 1 of 5 with slight deformation |
| 5 | all 5 deformed | 3 of 5 with slight deformation |
| 6 | all 5 deformed | 5 of 5 with slight deformation |
| 7 | all 5 deformed | 3 of 5 with slight deformation |
| 8 | all 5 deformed | 5 of 5 with significant deformation |
| 9 | all 5 deformed | 5 of 5 with significant deformation |
| 10 | all 5 deformed | 5 of 5 with significant deformation |

### Top Load Testing

The top load capacity of a blow molded bottle is the maximum amount of force that may be applied to a bottle without causing the bottle to deform. Blow molded bottles with a layer configuration of 20/60/20 having the composition of samples 1 through 10 were tested according to method ASTM D2659 for the average load in kgf at yield and at break.

### Top Load Results:

| | Average Load at Yield | Average Load at Break |
|---|---|---|
| Sample | (kgf) | (kgf) |
| 1 | 18.8 ± 1.4 | 25.5 ± 2.0 |
| 2 | 18.6 ± 1.7 | 23.8 ± 1.8 |
| 3 | 18.9 ± 1.6 | 25.0 ± 3.9 |
| 4 | 21.1 ± 0.3 | 27.5 ± 1.1 |
| 5 | 18.5 ± 2.0 | 27.0 ± 1.5 |
| 6 | 17.3 ± 2.2 | 24.7 ± 5.1 |
| 7 | 15.7 ± 1.5 | 18.6 ± 1.1 |
| 8 | 21.1 ± 5.2 | 22.2 ± 5.2 |
| 9 | 20.2 ± 4.6 | 25.2 ± .7 |
| 10 | 19.2 ± 0.8 | 26.2 ± 4.4 |

### Average Weight for Tested Formulations:

| Sample | Average Weight (g) |
|---|---|
| 1 | 29.14 |
| 2 | 28.04 |
| 3 | 27.61 |
| 4 | 28.45 |
| 5 | 28.27 |
| 6 | 28.16 |
| 7 | 27.71 |
| 8 | 27.39 |
| 9 | 28.05 |
| 10 | 28.78 |
| Average | 28.16 |
| Standard Deviation | 0.53 |

### Example 4: Pressurized Bottle Testing

Bottles were blow molded according to an embodiment. Bottles were made with 20/70/10 layer structure. The bottles were tested for Drop Testing, Top Loading and an ASTM D2561 variant of ESCR testing called ESCR F50. This test measures the number of hours until 50% of the bottles fail in a 140° F. oven.

### Example 5: Testing Blow Molded Bottles Including Either 100% Virgin Resin, Virgin Resin Blended with Recycled Resin, and Either Virgin or Blended Resin Plus Graphene or the Graphene Masterbatch According to an Embodiment

Bottles blow molded according to an embodiment were tested for ESCR, Drop Test, and Top Loading. Bottles were molded in a 20/70/10 layer configuration. The masterbatch of bottles 1 through 6 and 8 comprised 30 wt % of a graphene component supplied in powder form, with a primary particle size of 1-2 uM, and an agglomerate size of D50<38 uM. The graphene component had greater than 96 wt % graphene and less than 1 wt % oxygen. The graphene component ranged from 6 to 10 layers, had a bulk density of 0.2 to 0.3 g/cm3 and was insoluble. The graphene component had less than 0.5 wt % moisture and less than 4 wt % ash content.

The masterbatch of bottle #7 comprised 30 wt % of a graphene component supplied in powder form, with a primary particle size of 0.5 to 1 uM. The graphene component had an agglomerate size of D50<13 uM. The graphene component had greater than 96 wt % graphene and less than 1 wt % oxygen. The graphene component ranged from 6 to 10 layers, had a bulk density of 0.14 g/cm³ and was odorless and insoluble. The graphene component had less than 0.6 wt % moisture and from 2 to 3 wt % ash content.

The 5504 resin (Paxon™ SP 5504 supplied by Exxon Mobil of Houston, Texas) is a high density polyethylene copolymer with melt index of 0.35 g/10 min. at 190° C., and a density of 0.955 g/cm³. Samples 2-4 included PCR recovered from oceans and/or beaches (4Ocean). Samples 5, 6, and 7 included a post-consumer resin KWR102 supplied by KW plastics of Troy, Alabama.

| Bottle | Outer | Middle | Inner | Total | Drop | Top | ESCR |
|---|---|---|---|---|---|---|---|
| # | (20) | (70) | (10) | PCR | (ft.) | (lb.) | F50 |
| 1 | 100% | 100% | 100% | 0% | 15.25 | 111.28 | 50 |
| | 5504 | 5504 | 5504 | | | | |
| 2 | 100% | 100% | 100% | 70% | 15.15 | 80.27 | 124 |
| | 5504 | 4Ocean | 5504 | | | | |
| 3 | 100% | 98.3% | 100% | 69% | 14.83 | 90.91 | 274 |
| | 5504 | 4Ocean, | 5504 | | | | |
| | | 1.7% | | | | | |
| | | Graphene | | | | | |
| 4 | 100% | 96.7% | 100% | 68% | 14.89 | 81.77 | 827 |
| | 5504 | 4Ocean, | 5504 | | | | |
| | | 3.3% | | | | | |
| | | Graphene | | | | | |
| 5 | 100% | 100% | 100% | 70% | 15.25 | 87.64 | 842 |
| | 5504 | KWR102 | 5504 | | | | |
| 6 | 100% | 98.3% | 100% | 69% | 15.15 | 83.41 | 877 |
| | 5504 | KWR102, | 5504 | | | | |
| | | 1.7% | | | | | |
| | | Graphene | | | | | |
| 7 | 100% | 96.7% | 100% | 68% | 15.15 | 112.74 | 210 |
| | 5504 | KWR102, | 5504 | | | | |
| | | 3.3% | | | | | |
| | | PM811503 | | | | | |
| 8 | 100% | 98.3% | 100% | 0% | 15.25 | 127.14 | 348 |
| | 5504 | 5504, 1.7% | 5504 | | | | |
| | | Graphene | | | | | |

### Example 6: ESCR Testing of SP5504 Graphene Resin

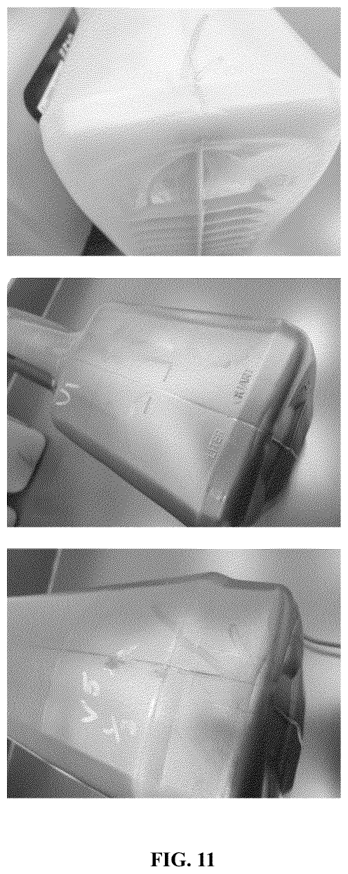

30 bottles (15 at ⅓ full and 15 at full) 3 for each variable were filled with a 10% Igepal and 90% water solution; capped and sealed; and placed into a 140° F. environmental chamber for a 14 day test with no weights. The bottles were observed daily for failures. FIG. 11 illustrates examples of failures observed in some of the bottles.

### Results for ⅓ Full Bottles:

| Resin | Cavities | Days to Fail | Comments |
|---|---|---|---|
| V1 3% Graphene 190 g | A-13 | 1 | handle side |
| V1 3% Graphene 190 g | A-13 | 1 | handle side |
| V1 3% Graphene 190 g | A-13 | 3 | handle and neck side |
| V2 Control | A-13 | 1 | handle side |
| V2 Control | A-13 | 1 | neck side |
| V2 Control | | | |
| V3 Control | A-13 | 1 | handle side |
| V3 Control | A-13 | 1 | handle side |
| V3 Control | A-13 | 2 | neck side |
| V4 3% Graphene | A-13 | 1 | neck side |
| V4 3% Graphene | A-13 | 1 | neck side |
| V4 3% Graphene | A-13 | 1 | handle and neck side |
| V5 4.5 Graphene | A-13 | 1 | handle and opp. side |
| V5 4.5 Graphene | A-13 | 2 | handle side |
| V5 4.5 Graphene | | | |

### Results for Full Bottles:

| Resin | Cavities | Days to Fail | Comments |
|---|---|---|---|
| V1 3% Graphene 190 g | | | |
| V1 3% Graphene 190 g | | | |
| V1 3% Graphene 190 g | | | |
| V2 Control | A-13 | 1 | neck side |
| V2 Control | A-13 | 11 | neck side |
| V2 Control | A-13 | 11 | neck side |
| V3 Control | A-13 | 1 | handle side |
| V3 Control | A-13 | 1 | handle side |
| V3 Control | A-13 | 1 | handle side |
| V4 3% Graphene | | | |
| V4 3% Graphene | | | |
| V4 3% Graphene | | | |
| V5 4.5 Graphene | | | |
| V5 4.5 Graphene | | | |
| V5 4.5 Graphene | | | |

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A masterbatch composition comprising:
10 to 30 wt % of a graphene component; and
60 to 90 wt % a carrier resin, wherein the graphene component has a particle size of 1 to 2 uM and a bulk density of 0.2 to 0.3 g/cm³.

2. The masterbatch composition of claim 1, wherein the graphene component has an agglomerate size of D50<38 uM.

3. The masterbatch composition of claim 1, wherein the graphene component has less than 0.5 wt % moisture and less than 4 wt % ash content.

4. The masterbatch composition of claim 1, wherein the graphene component ranges from 6 to 10 layers.

5. The masterbatch composition of claim 1, further comprising one or more of a polyolephin and/or maleated wax, a stearate, and an amide-based component.

6. The masterbatch composition of claim 1, wherein the carrier resin is a linear low density polyethylene.

7. The masterbatch composition of claim 1, wherein the melt flow rate of the carrier resin is higher than the melt flow rate of the base resin to which it is added.

8. The masterbatch composition of claim 1, wherein the carrier resin has a melt flow rate of around 7 to 20 g/10 min. at 190 C.

9. A masterbatch composition comprising:
10 to 30 wt % of a graphene component; and
60 to 90 wt % a carrier resin, wherein the graphene component has a particle size of 0.5 to 1 uM and a bulk density of 0.14 g/cm³.

10. The masterbatch of claim 9, wherein the graphene component has an agglomerate size of D50<13 uM.

11. The masterbatch composition of claim 9, wherein the graphene component is odorless and insoluble.

12. The masterbatch composition of claim 9, wherein the graphene component has less than 0.6 wt % moisture and from 2 to 3 wt % ash content.

13. The masterbatch composition of claim 9, wherein the graphene component ranges from 6 to 10 layers.

14. The masterbatch composition of claim 9, further comprising one or more of a polyolephin and/or maleated wax, a stearate, and an amide-based component.

15. The masterbatch composition of claim 9, wherein the carrier resin is a linear low density polyethylene.

16. The masterbatch composition of claim 9, wherein the melt flow rate of the carrier resin is higher than the melt flow rate of the base resin to which it is added.

17. The masterbatch composition of claim 9, wherein the carrier resin has a melt flow rate of around 7 to 20 g/10 min. at 190 C.

18. A blend comprising:
1 to 7% of the masterbatch composition of claim 1; and
a base resin.

19. A blend comprising:
1 to 7% of the masterbatch composition of claim 9; and
a base resin.

20. A blend comprising:
1 to 7% of a masterbatch composition including:
10 to 30 wt % of a graphene component, and
60 to 90 wt % a carrier resin, wherein the graphene component has a particle size of 1 to 2 uM and a bulk density of 0.2 to 0.3 g/cm³; and
a base resin.
